(19) United States
(12) Patent Application Publication
(10) Pub. No.: US 2008/0084704 A1
(43) Pub. Date: Apr. 10, 2008

(54) ILLUMINATED MUD GUARD

(75) Inventors: Daisuke Kobayashi, Niiza-shi (JP); Kazuyuki Asuwa, Niiza-shi (JP); Daisuke Watanabe, Niiza-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA ACCESS CORP., Saitama-ken (JP)

(21) Appl. No.: 11/870,033

(22) Filed: Oct. 10, 2007

(30) Foreign Application Priority Data
Oct. 10, 2006 (JP) 2006-276830

(51) Int. Cl. B60Q 1/26

(52) U.S. Cl. 362/495

(57) ABSTRACT

An illuminated mud guard with improved durability. An illuminated mud guard includes: a mud guard body provided in a part of a vehicle body behind wheels of a vehicle; and an illuminating device provided in the mud guard body. The mud guard body comprises: a front member facing the wheels for receiving mud; and a rear member formed opposite to the front member with a clearance therebetween. The illuminating device is provided in the rear member.

### BACKGROUND OF THE INVENTION

1. Field of the Invention

The present invention relates to a mud guard provided in a vehicle, particularly to an illuminated mud guard having an illuminating device for illuminating a step of a passenger in the vicinity of doors of the vehicle.

2. Description of Related Art

Japanese Utility Model Application Publication No. H06-57776, for example, discloses an illuminated mud guard of this type, which is not only to guard against splashes, mud, stones, snow, etc. from wheels, but also to illuminate a step of a passenger when opening a door of the vehicle in the dark during parking or stoppage, for which is provided a while light that is directed obliquely backward from the front wheel mud guard. The prior mud guard has a beneficial effect such that passengers can feel safe to get in the vehicle at night because their steps are illuminated when sitting on a front or rear seat.

According to the prior art, however, there have been concerns that the illuminating device is liable to get out of order by the impact received by a mud guard. That is, a mud guard is subjected to shocks or impacts by splashes, mud, stones, lumps of snow, etc. during the travel. In some cases, it is subjected to a strong impact due to a user kicking it to remove mud or snow that was stuck thereto. Thus, the impact received by the mud guard is transferred directly to the illuminating device, which presumably causes the illuminating device to get out of order more easily.

### SUMMARY OF THE INVENTION

In view of the above problems, it is, therefore, an object of the present invention to provide an illuminated mud guard with improved durability.

To achieve the above object, there is proposed an illuminated mud guard according to a first aspect of the invention, comprising:

a mud guard body provided in a part of a vehicle body behind wheels of a vehicle; said mud guard body comprising a front member facing said wheels for receiving mud; and a rear member formed opposite to said front member with a clearance therebetween, and

an illuminating device provided in said mud guard body, said illuminating device being installed in said rear member.

According to the illuminated mud guard of a second aspect of the invention, said rear member is formed from a resin material.

According to the illuminated mud guard according to a third aspect, said mud guard body is provided in a part of the vehicle body behind front wheels, while said illuminating device illuminates a step of a passenger in the vicinity of a door of the vehicle.

According to the illuminated mud guard according to a fourth aspect, said mud guard body is of a bottomed structure, including at least one drain hole provided in a lower portion of said mud guard body.

According to the illuminated mud guard according to a fifth aspect, said illuminating device is provided in a surface of said rear member in a depressed manner.

According to the illuminated mud guard of the first aspect, the impact received by the front member can be softened, thus enabling the improvement of the durability of the illuminating device.

According to the illuminated mud guard of the second aspect, the impact from the outside can be prevented from being transferred directly to the illuminating device, thus enabling the durability of the illuminating device to be improved further.

Moreover, according to the illuminated mud guard of the third aspect, a user can get on or off a vehicle easily even at night.

Also, according to the illuminated mud guard of the fourth aspect, water which has got into the inside of the mud guard body can be discharged smoothly, and the durability of the illuminating device can be improved.

Still also, according to the illuminated mud guard of the fifth aspect, even when a user kicks the mud guard, it is possible to keep a user's leg from coming in contact with the illuminating device, and thus the durability thereof can be improved. Moreover, when traveling on a wet road surface, atomized dirt splashed by the rotation of tires etc. can be made less likely to adhere to the illuminating device, thus ensuring a user's step to be reliably illuminated when it is necessary.

### BRIEF DESCRIPTION OF THE DRAWINGS

FIG. 1 is a perspective view showing an illuminated mud guard of a first embodiment of the invention attached to a vehicle.

FIG. 2 is a perspective view showing an overall structure of the illuminated mud guard of the first embodiment of the invention.

FIG. 3 is a partially enlarged view showing a structure of an illumination window for the illuminated mud guard of the first embodiment of the invention.

FIG. 4 is a transverse section of the illuminated mud guard of the first embodiment of the invention.

FIG. 5 is a perspective view showing a structure of a bracket for the illuminated mud guard of the first embodiment of the invention.

FIG. 6 is a perspective view showing the illuminating device being fixed to the bracket in accordance with the first embodiment of the invention.

FIG. 7 is a perspective view showing the illuminating device being attached to the mud guard body in accordance with the first embodiment of the invention, in which FIG. 7(A) is a view seen from a front member side, while FIG. 7(B) a view seen from a rear member side.

FIG. 8 is an enlarged longitudinal section of the illuminated mud guard in accordance with the first embodiment of the invention.

FIG. 9 is a plan view showing an illuminated mud guard in accordance with a second embodiment of the invention.

FIG. 10 is a partially enlarged view showing a structure of an illumination window for the illuminated mud guard of the second embodiment of the invention.

FIG. 11 is a perspective view showing a structure of a bracket for the illuminated mud guard of the second embodiment of the invention.

FIG. 12 is an enlarged longitudinal section of the illuminated mud guard of the second embodiment of the invention, specifically illustrating the vicinity of the illumination window thereof.

FIG. 13 is a view showing the illuminated mud guard of the invention as viewed from inside.

### DETAILED DESCRIPTION OF THE INVENTION

### First Embodiment

Next is a description of a first embodiment of the present invention with reference to the attached drawings.

An illuminated mud guard 1 shown in FIG. 1 comprises a mud guard body 4 provided in a part of a vehicle body 3 behind a front wheel of a vehicle 2; and an illuminating device 5 provided in the mud guard body 4. The illuminated mud guard I is constituted, as a whole, so that it may guard against the splashes of mud from a wheel 6, and illuminate the step of a user when getting on or off the vehicle 2 through a door 7. The mud guard body 4 is attached to a posteroinferior section of a wheel house 8 of the front wheel in such a manner that it extends continuously with respect to the wheel house 8.

The illuminating device 5 is provided at the back side of the mud guard body 4, and electrically connected with a control unit 10 through harness 9 so that the illuminating device 5 may be switched on or off at a predetermined timing. For example, the illuminated mud guard 1 may switch on the illuminating device 5 in association with a door unlocking action and switch off the same in association with a door locking action, an engine starting action, a door closing action, etc. by means of a remote control device (not shown) for remote control of locking and unlocking the doors 7.

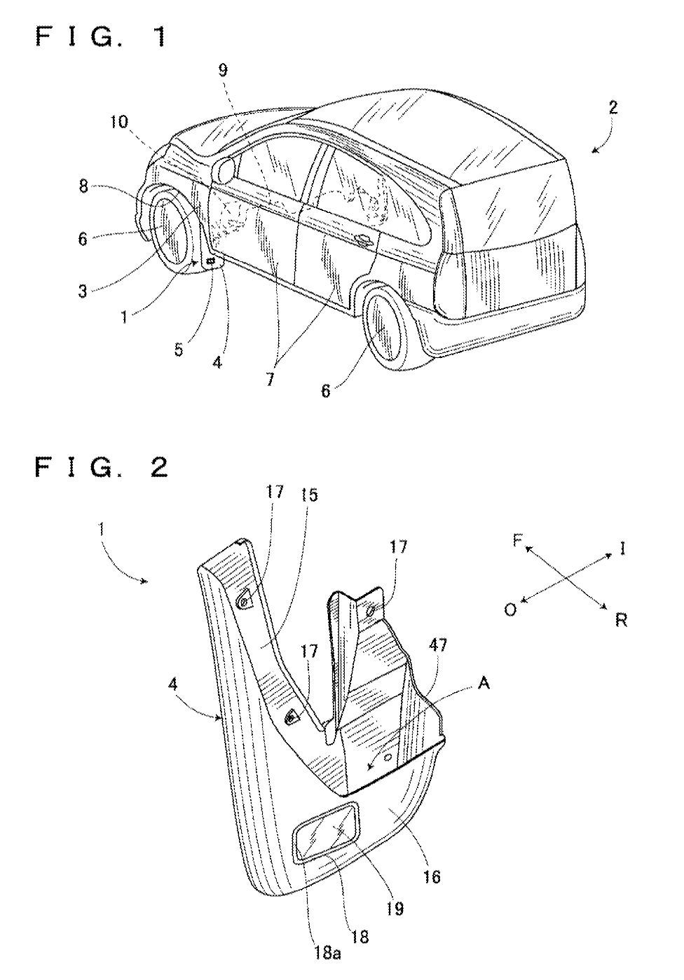

Next will be described in detail the structure of the illuminated mud guard 1 with reference to FIG. 2. In the meantime, since the illuminated mud guard 1 provided in each wheel 6 has the same fundamental structure and is symmetrical to each other, the illuminated mud guard 1 provided on the left side of the vehicle 2 will be explained hereinafter for convenience of explanation. The mud guard body 4 is composed of a substantially L-shaped member integrally formed from a resin material. The mud guard body 4 comprises a front member 15 facing the wheel 6 to receive mud, and a rear member 16 formed so as to face the front member 15 with a clearance A therebetween. The front member 15 and the rear member 16 define an opening at a top, and are connected to each other at a bottom and sides (both in direction 0 and direction I in FIG. 2) so that they are formed into a single piece.

Screw holes 17 for inserting screws (not shown) for fixing the illuminated mud guard 1 to the wheel house 8 are provided in the front member 15. The rear member 16 inclines gently toward the front direction (direction F in FIG. 2) as it extends outwards (direction O in FIG. 2), and are provided with an illumination window 18 for letting the light from the illuminating device 5 therethrough. The illumination window 18 comprises a rectangular hole formed through the rear member 16, and is formed through a surface located slightly outer side in the rear member 16, i.e., a surface gently inclining toward the front (toward the direction F in FIG. 2).

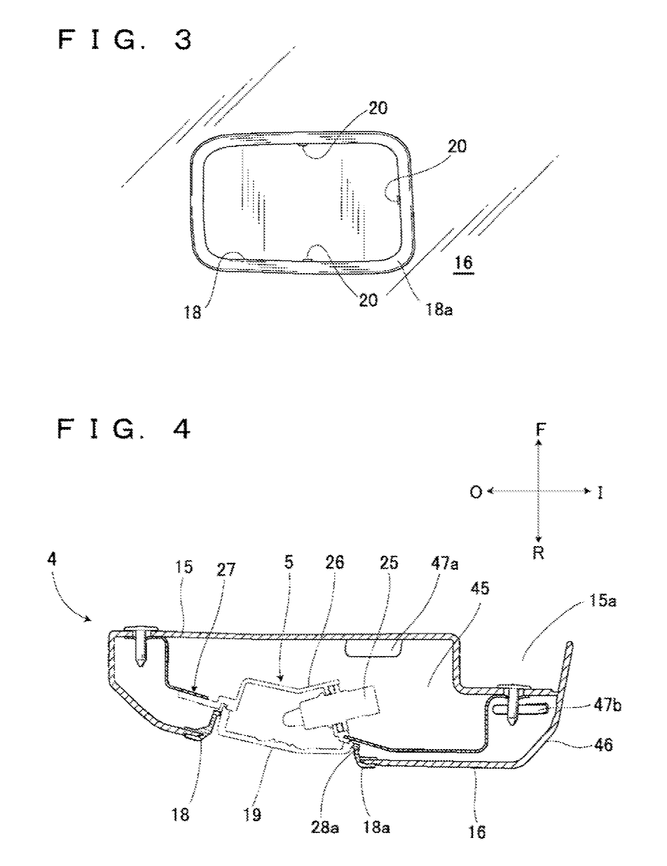

As shown in FIG. 3, two or more ribs 20 for holding a lens 19 in a center position are provided in the illumination window 18. Incidentally, according to the present embodiment, garnish 18a is fitted in the illumination window 18, with said ribs 20 being provided in the garnish 18a.

As shown in FIG. 4, the illuminating device 5 comprises: a casing body 26 including a connector 25 connecting with a harness 9; and a lens 19 provided in the casing body 26. The illuminating device 5 is fixed between the front member 15 and the rear member 16 with the lens 19 being exposed to the outside from the illumination window 18 through a bracket 27. A window frame 28a is formed on a rear surface of the rear member 16 in a manner protruding from around the illumination window 18. According to the present embodiment, the window frame 28a is formed integrally with the garnish 18a.

Further, one or more drain holes 47 are formed in the mud guard body 4 in the present embodiment, multiple (i.e., two) drain holes 47a, 47b are provided. One drain hole 47a is defined by a rectangular hole formed substantially in the center of a bottom 45 of the mud guard body 4. The other drain hole 47b is defined by a rectangular hole the opening of which extends from an inner area of the bottom 45 to the inner side surface 46 of the mud guard body 4. In FIG. 4, a concave portion 15a formed in an inner side (i.e., direction I in FIG. 4) portion of the front member is formed in order to engage with the wheel house 8 of the vehicle body 3.

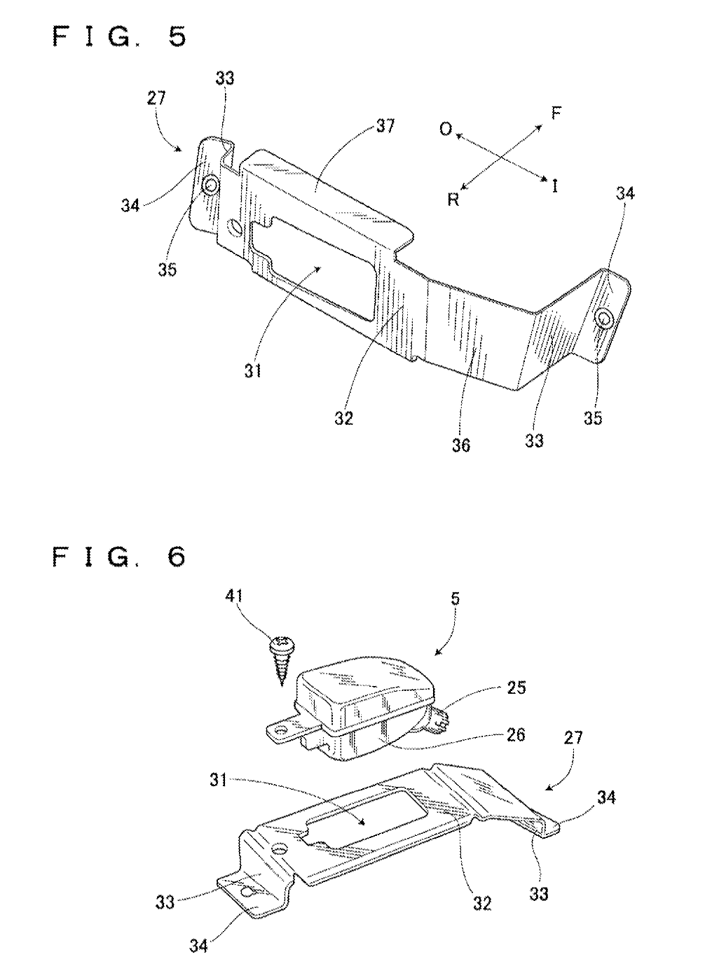

As shown in FIG. 5, the bracket 27 is composed of an oblong rectangular member formed from spring steel made of stainless steel, for example. The bracket 27 comprises: a retainer section 32 formed with a fixation hole 31 for retaining the illuminating device 5; a pair of pressing sections 33 formed by perpendicularly bending both longitudinal ends of the retainer section 32; and seats 34 each of which is abutted to a rear surface of the front member 15 of the mud guard body 4, said seats 34 being each provided with an insertion hole 35. The fixation hole 31 comprises a rectangular hole similar in shape to the illumination window 18, and is formed a little to the outside (to the O side in FIG. 5) from the substantial center of the bracket 27.

The retainer section 32 comprises an abutting surface 36 for abutting to the rear surface of the rear member 16 at the inside (to the direction I in FIG. 5) relative to the substantial center of the bracket 27 where the fixation hole 31 is not provided. Preferably, the pressing sections 33 may be each formed to a length substantially equal to a distance between the front member 15 and the rear member 16. Moreover, an engagement section 37 for engaging with the window frame 28a is integrally formed in the width direction of the bracket 27. Incidentally, in the present embodiment, the engagement section 37 is projected toward the front (in the direction of F in FIG. 5).

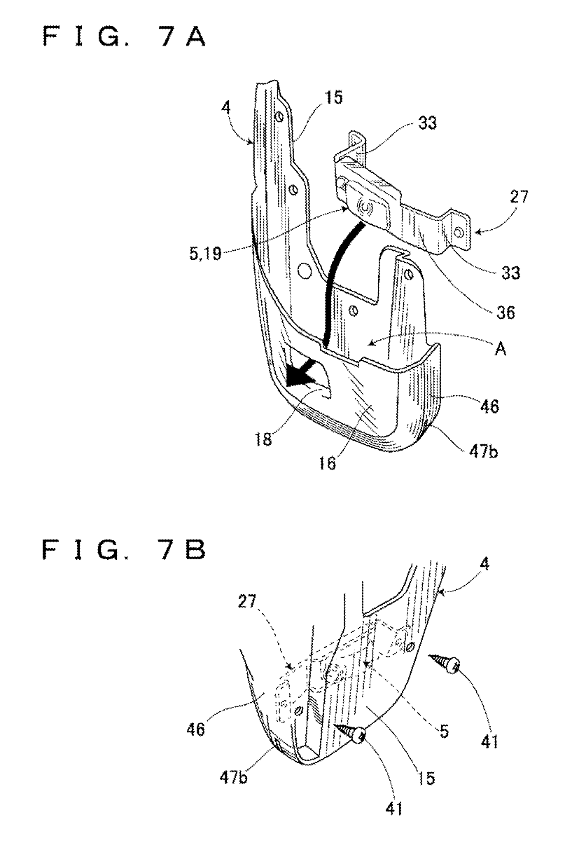

As shown in FIG. 6, the illuminating device 5 is fixed to the bracket 27 by inserting the casing body 26 into the fixation hole 31 so that the connector 25 may be projected toward the rear side of the bracket 27, and then fastening the same, using a screw 41. In order to fix the illuminating device 5 thus fixed to the bracket 27 to the mud guard body 4, the assembly thus obtained is first inserted into a clearance A between the front member 15 and the rear member 16, as illustrated in FIG. 7.

At this moment, due to the pressing sections 33 being each formed to a length substantially equal to the distance between the front member 15 and the rear member 16, the bracket 27 is clamped between the front member 15 and the rear member 16 with the abutting surface 36 being pressed to the rear surface of the rear member 16. Then, with the lens 19 being exposed from the illumination window 18, the screws 41 are inserted from the front member 15 side into the insertion hole 35 to thereby fix the bracket 27 to the mud guard body 4, as illustrated in FIG. 7(B). The illuminated mud guard 1 is constituted by fixedly attaching the illuminating device 5 to the mud guard body 4 in this way.

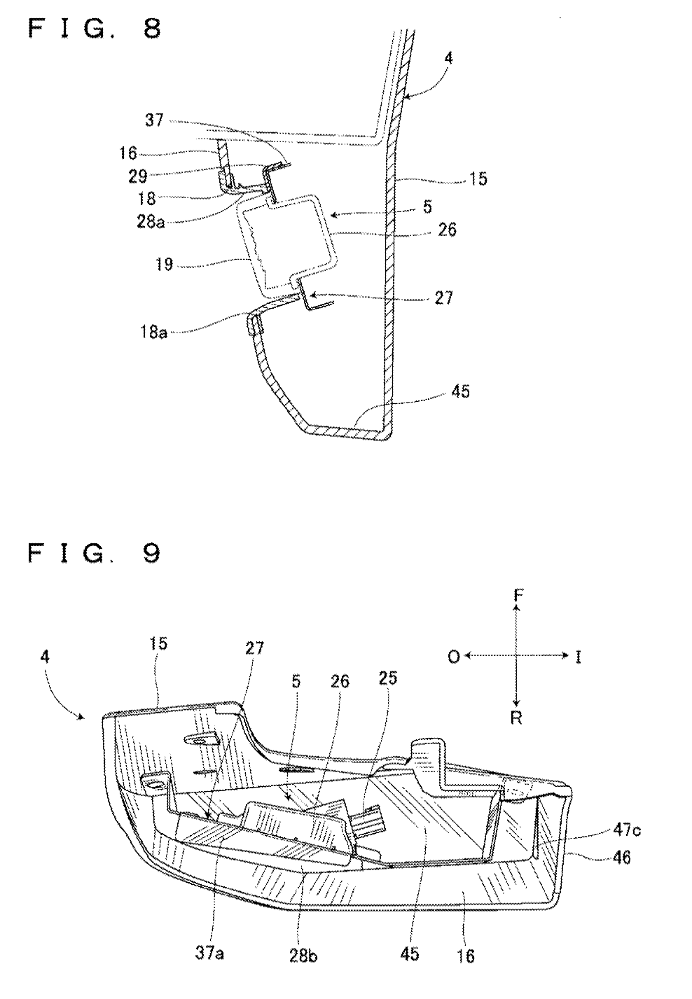

As shown in FIG. 8, the mud guard body 4 is constructed such that the front member 15 and the rear member 16 are connected to each other at the bottom 45. Thus, the rear member 16 can be formed flat from an upper end thereof to a lower end thereof. The illuminating device 5 is provided in the rear member 16 in a depressed manner by abutting the bracket 27 to the window frame 28a formed integrally with the garnish 18a fitted to the illumination window 18 of the rear member 16.

In other words, the surface of the lens 19 is located in a position depressed from the surface of the rear member 16 toward the rear side. Thus, according to the illumination mud guard 1, the illuminating device 5 is installed in the position depressed by one step from the surface of the rear member 16, and thus, when a user kicks it, for example, it is possible to prevent a user's leg from directly hitting the illuminating device 5, so that the durability of the illuminating device 5 can be improved.

Moreover, according to the illumination mud guard 1, the illuminating device 5 is installed in the position depressed by one step from the surface of the rear member 16, whereby atomized dirt splashed by the rotation of tires etc. can be made less likely to adhere to the illuminating device 5 when traveling on a wet road surface, thus ensuring a step to be certainly illuminated when it is necessary.

Also, the bracket 27 is provided with a seal material 29 in a portion abutting to the window frame 28a. The seal material 29 is composed of a member capable of shielding light from the illuminating device 5, such as a sheet member made of a foamed material, provided in a portion of the bracket 27 abutting to the window frame 28a, specifically in a portion abutting to the upper section thereof, via an adhesive or the like.

Accordingly, according to the illuminated mud guard 1, the light of the illuminating device 5 can be prevented from leaking from the upper surface of the illumination window 18 into the mud guard body 4, and besides, leak of light from where the mud guard body 4 is attached to the vehicle body 3 can also be prevented.

Moreover, the bottom 45 slopes down from an outer side (the direction O in FIG. 2) relative to the mud guard body 4 toward an inner side (the direction I of FIG. 2) thereof, and said drain hole 47b is provided in the inner side surface of the mud guard body 4.

The illuminated mud guard 1 constituted as above can illuminate the neighborhood of a door that is close to passenger's feet. As a result, the illuminated mud guard 1 enables a user to get on or get off the vehicle easily at night.

Further, the front member 15 of the illuminated mud guard 1 can receive the splashes of mud from the wheels 6 during the travel of the vehicle 2, thus serving as a guard against dirt or damage to the vehicle body 3. Furthermore, the illuminated mud guard 1 is of a dual structure comprising the front member 15 that receives splashes of mud, and the rear member 16 provided with the clearance A between the front member 15 and the same, and besides, the illuminating device 5 is provided in the rear member 16. Thus, according to the illuminated mud guard 1, the shock transmitted from the front member 15 to the rear member 16 can be eased, and the durability of the illuminating device 5 can be improved.

Moreover, the illuminated mud guard 1 allows the front member 15 to be formed without being subjected to restrictions from the shape of the rear member 16 due to such dual structure. Thus, the front member 15 can be formed into a flat shape, and thus, mud, snow, etc. can be prevented from adhering or being deposited on the surface of the front member 15.

Still moreover, the illuminated mud guard 1 can allow the shock from outside to be absorbed in the rear member 16 due to the rear member 16 being formed from a resin material. Thus, according to the illuminated mud guard 1, it is possible to prevent the shock from outside from being transferred directly to the illuminating device 5, and thus the durability of the illuminating device 5 can be improved.

Additionally, the illuminated mud guard 1 makes it possible to keep the clearance between the lens 19 and the garnish 18a constant due to the provision of ribs 20 in the garnish 18a fitted to the illumination window 18.

Further, the illuminated mud guard 1 can absorb the shock from outside in the bracket 27 as well due to the bracket 27 being formed from spring steel. Thus, according to the illuminated mud guard 1, the shock from outside can be absorbed more reliably, so that the displacement of the lens 19 can be prevented.

Moreover, the illuminated mud guard 1 slopes down toward the inside at the bottom 45 of the mud guard body 4, having the drain holes 47 formed in the bottom 45 and in the inner side surface 46, and thus the water taken in from the upper opening of the mud guard body 4 can be discharged smoothly, and the durability of the illuminating device 5 can be improved.

Still moreover, since the drain hole 47b is provided in the inner side surface 46 of the mud guard body 4, water can be discharged reliably without impairing appearance. Furthermore, since the multiple drain holes are provided such that the one drain hole 47a is formed in the bottom 45, while the other drain hole 47b in the inner side surface 46, water can be discharged reliably from the other drain hole 47b, even when the vehicle travels on a snowy road so that the bottom 45 freezes and the one drain hole 47a is closed.

Besides, the illuminated mud guard 1 can strengthen its structure due to the mud guard body 4 being of a bottomed structure.

Also, the illuminated mud guard 1 enables the bracket 27 to be easily installed in a predetermined position due to the engagement section 37 engaging with the window frame 28a being provided at the end of the bracket 27 in the width direction thereof.

Still also, due to the abutting surface 36 being provided in the retainer section 32 of the bracket 27, the contact area with the rear member 16 is increased, thus ensuring the illuminating device 5 to be retained more reliably.

In addition, it is possible for the illuminated mud guard 1 to reliably illuminate the neighborhood of feet of a user who is going to get on or get off the vehicle due to the illumination window 18 being formed through a specific area of the rear member 16, i.e., a surface located slightly close to the outside of the rear member 16, which, in other words, is a surface gently inclining toward the front (toward the direction F in FIG. 2).

### Second Embodiment

Hereinafter will be described a second embodiment of the present invention with reference to the attached drawings, in which the same structural elements as those described in the first embodiment will be designated by the same reference numerals, and their repeated description will be omitted.

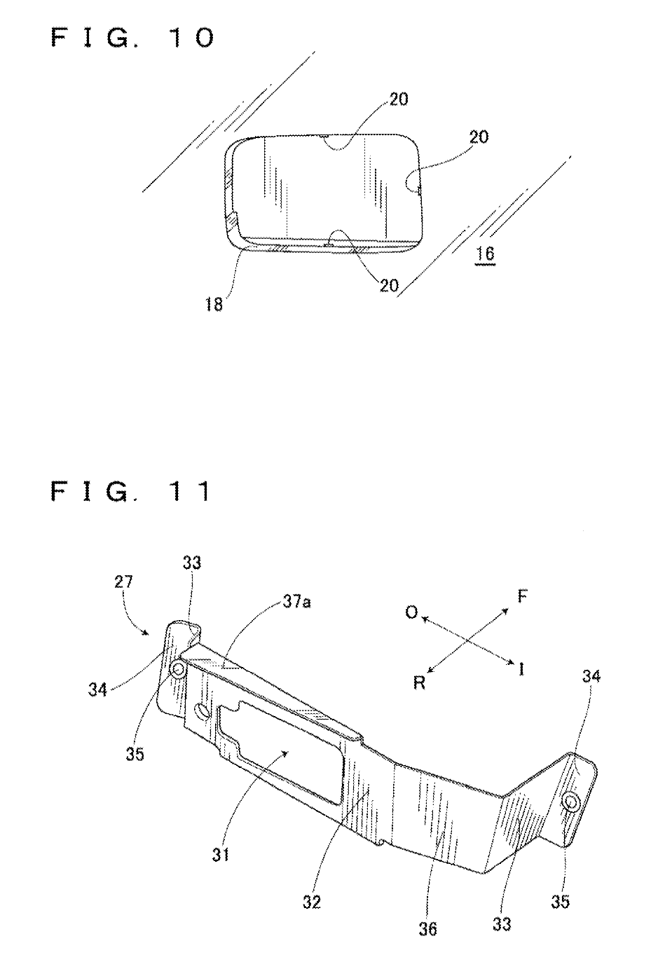

As shown in FIG. 9, the illuminating device 5 comprises: the casing body 26 including the connector 25 connecting with the harness 9; and the lens 19 provided in the casing body 26. The illuminating device 5 is fixed between the front member 15 and the rear member 16 with the lens 19 being exposed to the outside from the illumination window 18 through the bracket 27. The window frame 28a is formed on a rear surface of the rear member 16 in a manner protruding from around the illumination window 18. As shown in FIG. 10, the multiple ribs 20 for retaining the lens 19 in the center position are provided in the illumination window 18.

The bracket 27 shown in FIG. 11 differs from that of the first embodiment in respect of the shape of the engagement section 37. That is, the bracket 27 of the second embodiment comprises an engagement section 37a projecting toward the rear of the vehicle (the direction R in FIG. 11).

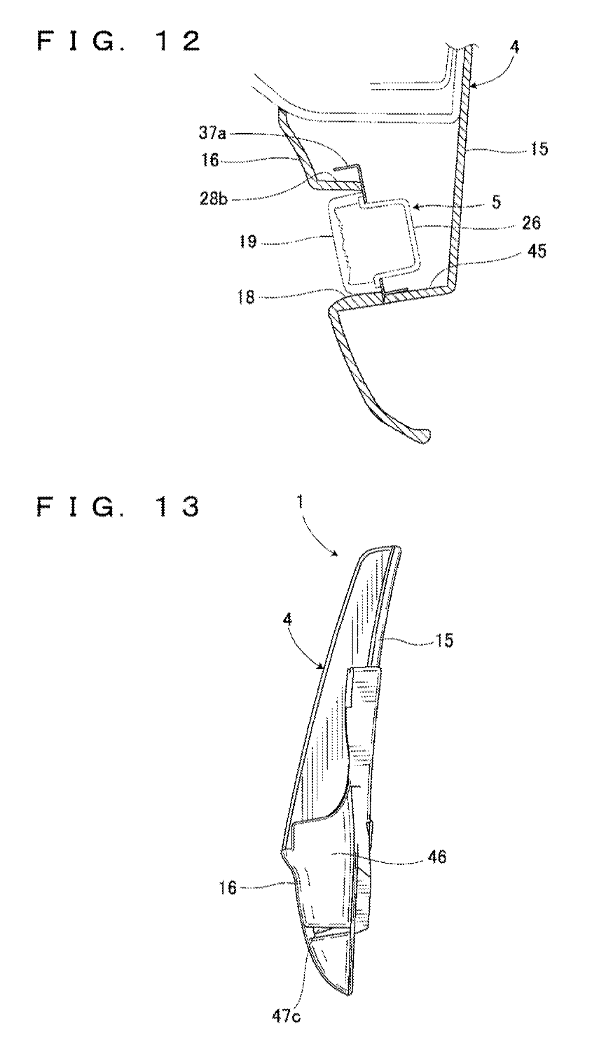

As shown in FIG. 12, the mud guard body 4 is installed in such a manner that the engagement section 37a projecting toward the rear of the vehicle 2 is allowed to abut to the rear surface of the rear member 16 above the window frame 28b formed so as to protrude from the rear surface of the rear member 16. Thus, according to the illuminated mud guard 1 of the second embodiment, the light of the illuminating device 5 can be prevented from leaking from where the mud guard body 4 is attached to the vehicle body 3.

Furthermore, the lower end of the front member 15 and the rear member 16 are connected to below the window frame 28b, while the lower end of the rear member 16 is slightly curved toward the front. The bottom 45 slopes down from the outside of the mud guard body 4 toward the inner side thereof. A drain hole 47c is provided in an intersection portion between the thus down-sloped bottom 45 and the inner side surface 46 of the mud guard body 4, as shown in FIG. 13.

In this way, according to the illuminated mud guard 1 of the second embodiment, the mud guard body 4 allows the lower end of the front member 15 and the rear member 16 to be connected to below the window frame 28, and thus the window frame 28b can be integrally formed, thereby reducing manufacturing cost.

In the meantime, the present invention is not limited to the foregoing embodiments, but various modifications are possible within the scope of the present invention. For example, although the illuminated mud guard 1 of the foregoing embodiments are provided in the wheel house 8 for front wheel, it may be provided in a wheel house for rear wheel. In that case, the illuminating device 5 provided in the mud guard body 4 is capable of illuminating the rear side of the vehicle 2, a user can feel safe to reverse the vehicle 2 at night.

In addition, although the illumination window 18 of the foregoing embodiments is of a rectangular shape, in conformity with the shape of the lens 19, the lens may be a circular one, and in that case, the illumination window 18 may also be a circular one.

What is claimed:

1. An illuminated mud guard comprising:
a mud guard body provided in a part of a vehicle body behind wheels of a vehicle; said mud guard body comprising a front member facing said wheels for receiving mud, and a rear member formed opposite to said front member with a clearance therebetween; and
an illuminating device provided in said mud guard body, said illuminating device being installed in said rear member.

2. The illuminated mud guard according to claim 1, wherein said rear member is formed from a resin material.

3. The illuminated mud guard according to claim 1, wherein said mud guard body is provided in a part of the vehicle body behind front wheels, while said illuminating device illuminates a step of a passenger in the vicinity of a door of the vehicle.

4. The illuminated mud guard according to claim 2, wherein said mud guard body is provided in a part of the vehicle body behind front wheels, while said illuminating device illuminates a step of a passenger in the vicinity of a door of the vehicle.

5. The illuminated mud guard according to claim 1, wherein said mud guard body is of a bottomed structure, including at least one drain hole provided in a lower portion of said mud guard body.

6. The illuminated mud guard according to claim 2, wherein said mud guard body is of a bottomed structure, including at least one drain hole provided in a lower portion of said mud guard body.

7. The illuminated mud guard according to claim 3, wherein said mud guard body is of a bottomed structure, including at least one drain hole provided in a lower portion of said mud guard body.

8. The illuminated mud guard according to claim 4, wherein said mud guard body is of a bottomed structure, including at least one drain hole provided in a lower portion of said mud guard body.

9. The illuminated mud guard according to claim 1, wherein said illuminating device is provided in a surface of said rear member in a depressed manner.

10. The illuminated mud guard according to claim 2, wherein said illuminating device is provided in a surface of said rear member in a depressed manner.

11. The illuminated mud guard according to claim 3, wherein said illuminating device is provided in a surface of said rear member in a depressed manner.

12. The illuminated mud guard according to claim 4, wherein said illuminating device is provided in a surface of said rear member in a depressed manner.

13. The illuminated mud guard according to claim 5, wherein said illuminating device is provided in a surface of said rear member in a depressed manner.

14. The illuminated mud guard according to claim 6, wherein said illuminating device is provided in a surface of said rear member in a depressed manner.

15. The illuminated mud guard according to claim 7, wherein said illuminating device is provided in a surface of said rear member in a depressed manner.

16. The illuminated mud guard according to claim 8, wherein said illuminating device is provided in a surface of said rear member in a depressed manner.

17. The illuminated mud guard according to claim 1, wherein said rear member is provided with an illumination window for exposing a lens for said illuminating device, said illumination window being provided with multiple ribs for retaining said lens in a center position.

18. The illuminated mud guard according to claim 5, wherein said at least one drain hole includes a first hole formed substantially in a center of a bottom of said mud guard body and a second hole extending from an inner area of said bottom to an inner side surface of said mud guard body.

19. The illuminated mud guard according to claim 18, wherein said bottom slopes down from an outer side relative to said mud guard body toward an inner side thereof.
